(19) United States
(12) Patent Application Publication
(10) Pub. No.: US 2016/0352726 A1
(43) Pub. Date: Dec. 1, 2016

(54) LOCATION-TIME EVENT LOGGING SYSTEMS AND METHODS

(71) Applicant: Elwha LLC, Bellevue, WA (US)

(72) Inventors: Roderick A. Hyde, Redmond, WA (US); Lowell L. Wood,, JR., Bellevue, WA (US)

(73) Assignee: Elwha LLC, Bellevue, WA (US)

(21) Appl. No.: 14/549,196

(22) Filed: Nov. 20, 2014

(51) Int. Cl. H04L 29/06; H04W 12/06; H04W 4/02

(52) U.S. Cl. CPC H04L 63/0861; H04W 4/028; H04L 63/083; H04L 63/105; H04L 63/102; H04W 12/06

(57) ABSTRACT

Systems and methods for generating and storing location-time data relating to a tracked user are described. The system includes a logging device including a location detector, a processor, a logging device memory, and a logging device communication interface. The logging device is configured to generate location-time data associated with the tracked user based on the occurrence of a trigger and to store the location-time data in the memory. The system further includes a system server including a server memory and a server communication interface. The logging device is configured to transmit the location-time data to the system server for storage in the server memory. Access to the location-time data is provided on a restricted bases based in part on at least one of a requestor identity and a purpose of the data request.

### BACKGROUND

Individuals are often asked to retroactively prove their whereabouts. For example, witnesses in court are often asked to verify their whereabouts at specific times during testimony. Aside from personal testimony, individuals may try to prove their whereabouts via electronic records. Current electronic systems that may be used in proving an individual's whereabouts at specific times include camera systems (e.g., building security camera systems), wireless communication systems (e.g., cell phone records), and the like. However, data generated from such systems is easily tampered with to falsify location and time information. For example, it is possible for wrongdoers to edit video data to include image data of an individual that was not originally present or to change the timestamp of captured image data. Additionally, location and time data based on cell phone signals may be edited by individuals having access to such information. Accordingly, current electronic systems are not guaranteed to be reliable to prove that an individual was or was not present at a given location at a specific time.

### SUMMARY

An embodiment relates to a personal location and time logging device. The device includes a location detector, a secure memory, and a processor. The processor is configured to receive location information from the location detector. The processor is configured to generate location-time data based on a trigger, the location-time data associated with an individual carrying the device. The processor is configured to store the location-time data in the secure memory. The processor is configured to provide restricted access to the location-time data based on permission of the individual.

Another embodiment relates to a system for generating and storing location-time data relating to a tracked individual. The system includes an individual carried logging device including a location detector, a processor, a logging device memory, and a logging device communication interface. The logging device is configured to generate location-time data associated with the tracked individual based on the occurrence of a trigger and to store the location-time data in the memory. The system further includes a system server including a server secure memory and a server communication interface. The logging device is configured to transmit the location-time data to the system server for storage in the server secure memory. Access to the location-time data is provided on a restricted basis based on a permission of the individual.

Yet another embodiment relates to a method of securely recording location-time information associated with an individual via a logging device carried by the individual. The method includes receiving, via a processor of the logging device, a data gathering trigger. The method includes receiving, via an input of the logging device, user verification information from the individual. The method includes authenticating, via the processor, an identity of the individual based on comparing the received user verification information with previously verified user information to verify the presence of the individual at or near the logging device. The method includes receiving, at the processor, location information from a location sensor of the logging device. The method includes creating, by the processor, a location-time entry including the location information and time information corresponding to a time of the location information. The method includes storing, in a secure memory of the logging device, the location-time entry.

A further embodiment relates to a method of accessing location-time information generated by a logging device via a user interface of the logging device, the location-time information associated with an individual. The method includes receiving, by a processor of the logging device and through the user interface, a request from a user to access a requested portion of the location-time information. The method includes receiving, via the user interface, provided user authentication information from the user. The method includes authenticating, by the processor, the user based on comparing the provided user authentication information with stored authentication information relating to the user. The method includes providing, via the user interface, the user access to the requested portion of the location-time information based on authenticating the user.

Another embodiment relates to a method of accessing location-time information generated by a logging device via an external computing device, the location-time information associated with an individual. The method includes establishing, via a communication interface of the logging device, a data connection between the logging device and the external computing device. The method includes receiving, by a processor, a request from the external computing device to access a requested portion of the location-time information, the request including an identity of a user making the request. The method includes receiving, via the communication interface, provided user authentication information from the user. The method includes authenticating, by the processor, the user based on comparing the provided user authentication information with stored authentication information relating to the user. The method includes transmitting, via the communication interface, the requested portion of the location-time information to the external computing device based on authenticating the user.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1 is a block diagram of a system for logging location-time data regarding an individual.

FIG. 2 is a block diagram of a location-time logging device.

FIG. 3 is a flow diagram of a method of programming and operating a location-time logging device.

FIG. 4 is a flow diagram of a method of accessing data logged by a location-time logging device via the logging device.

FIG. 5 is a flow diagram of a method of accessing data logged by a location-time logging device via an external computing device.

### DETAILED DESCRIPTION

In the following detailed description, reference is made to the accompanying drawings, which form a part thereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Referring to the figures generally, systems and methods for logging location-time data (e.g., the location of an individual at any particular time) regarding an individual are shown. It may become necessary for an individual to prove their whereabouts at a specific time. The disclosed systems and methods provide for secure logging of location-time data in a manner that prevents tampering of the logged location-time data, while allowing the individual the discretion to control which location-time data is recorded, and to control who has access to this data.

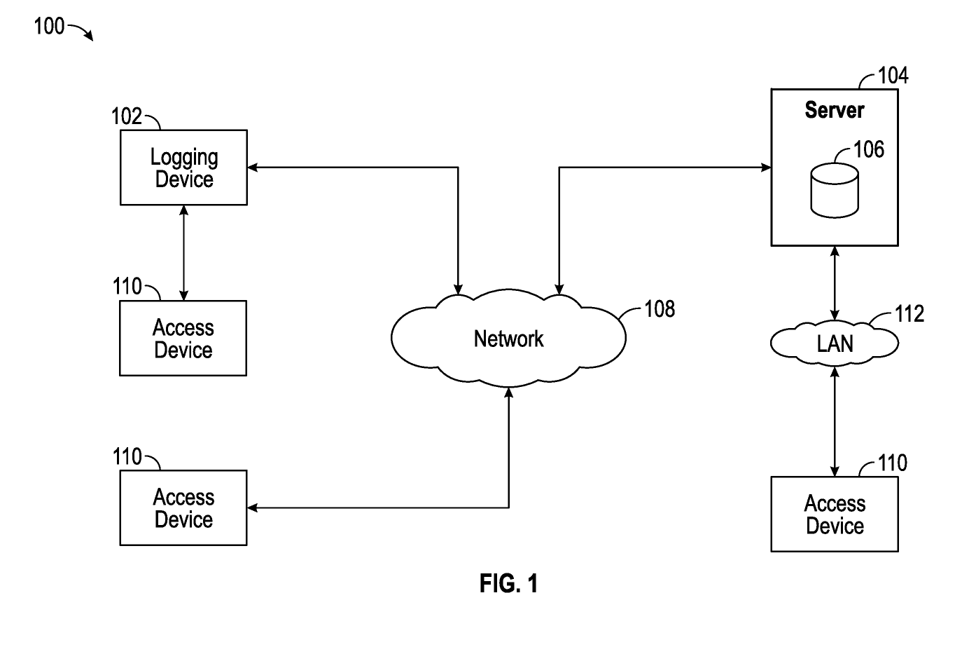

Referring to FIG. 1, a block diagram of system 100 for logging location-time data regarding an individual is shown according to one embodiment. System 100 includes logging device 102. Logging device 102 generates location-time data regarding an individual associated with logging device 102. Logging device 102 is carried by or kept near the individual to be monitored. During use, logging device 102 generates data (e.g., entries in a database stored in a memory of logging device 102) relating to the location of logging device 102 at specific points in time. Accordingly, the generated data is location-time data. The location-time data generated by logging device 102 generally corresponds to the location of the individual to be monitored (i.e., the location of logging device 102) at specific points in time.

The generated data is stored in a secure memory of the logging device 102. The generated data is stored in a manner to provide tamper-proof verification of the generated data (e.g., in a manner that prevents altering of the data after the data is generated). The tamper-proof storage of the data may be achieved through storing the data in a write-only memory, in a write-once memory, encrypting the data with an individual-unknown encryption/decryption method (e.g., such that the individual associated with the data does not have access to the necessary private key to decrypt the encrypted data), applying a digital watermark to the generated data that is destroyed if the generated data is modified, or a combination thereof. The generated data may be transmitted to server 104 via a communication interface. Server 104 includes a secure memory having database 106 to store the generated data from logging device 102. Server 104 also includes a server communication interface (e.g., a network interface) allowing server 104 to exchange data with external devices (e.g., logging device 102). Server 104 stores generated data from a plurality of logging devices, each logging device associated with a respective individual and/or organization. The generated data may be transmitted from logging device 102 to server 104 via network 108 (e.g., the Internet, a local-area network, a wide-area network, etc.).

Still referring to FIG. 1, the generated data is accessible from access devices 110. In one embodiment, access devices 110 are computing devices external to logging device 102. Access devices 110 may by any of desktop computers, laptop computers, PDAs, cell phones, smart phones, tablet computers, portable media devices, and the like. In some arrangements, access devices 110 access generated data stored in the memory of logging device 102 via a direct data connection with logging device 102. The direct data connection may be a wired connection (e.g., via a USB cable, via an Ethernet cable, fiber optic, etc.) or a wireless connection (e.g., via a Bluetooth connection, via a WiFi connection such as an 802.11a/b/g/n connection, via a ZigBee connection, via an infrared connection, via an ultrasound connection, etc.). In other arrangements, access devices 110 access generated data stored in the memory of logging device 102 via an indirect connection (e.g., via network 108). Network 108 is a wide-area network (e.g., the Internet). In still further arrangements, access devices 110 access generated data from logging device 102 that is stored in database 106 of server 104 via network 108 or network 112. Network 112 may be a local area network connected to server 104. In some arrangements, logging device 102 and access device 110 are an integrated device (e.g., a cell phone that acts as both a logging device and an access device).

In some arrangements, logging device 102 or server 104 provides restricted or limited access to location-time data generated by logging device 102 to access devices 110. The location-time data includes both location data and time data for a particular logging device. The location data may relate to a specific address or set of latitude and longitude coordinates. However, the specific street address or set of latitude and longitude coordinates may be reported to the data requestor in varying degrees of resolution. For example, depending on the access level of the access device 110 making the request, the location portion of the data may be reported as the specific address (most precise), as a neighborhood, as a town or city, as a county, as a state or province, or as a country (least precise). Similarly, the time data may relate to a specific time (e.g., 12:45:38 PM CST) of a specific date (e.g., Apr. 22, 2014). However, the specific time of the specific day may be reported to the data requestor in varying degrees of resolution. For example, depending on the access level of the access device 110 making the request, the time portion of the data may be reported as the specific time of the specific date (most precise), as a specific hour of a specific date, or as a specific date (least precise). The level of access to the generated location-time data depends on an access level granted to the user access device 110. The access level depends on a user identity or profession of the user of the access device 110 (e.g., a police officer, a lawyer, an employer, a medical professional, a lender, a family member, etc.), a purpose of the data request (e.g., court testimony, employment background check, family requests, personal requests of the individual, etc.), a level of access granted by the individual associated with the location-time data, or a combination thereof.

In some arrangements, the access provided to the location-time data created by logging device 102 is indirect. In such arrangements, the requestor of the access device can pose a question as to the whereabouts of the individual associated with logging device 102 and receive a yes or no answer in response to the question. Accordingly, the precise location-time data associated with the individual is not disclosed in the request. For example, if a requestor asks “Was individual X in Chicago, Ill. on Jan. 28, 2013?” the response from the system is a simple yes or no answer. In some embodiments, the requestor's question can be posed as a space-time range. For example, if the requester asks “Was individual X within 5 km of GPS coordinates X, Y between date D1 and D2?” the system can also respond with a yes or no answer. In some arrangements, the number of user requests is limited (e.g., limited to one request, two requests, three requests, and so on) thereby preventing a requestor from excessive guessing at the individual's space-time location.

Still further, the data generated by logging device 110 may be accessed via a user interface of logging device 102. Requestors accessing the data via logging device 102 are provided data in the varying degrees of resolution in the same manner as described above with respect to accessing the data via access devices 110.

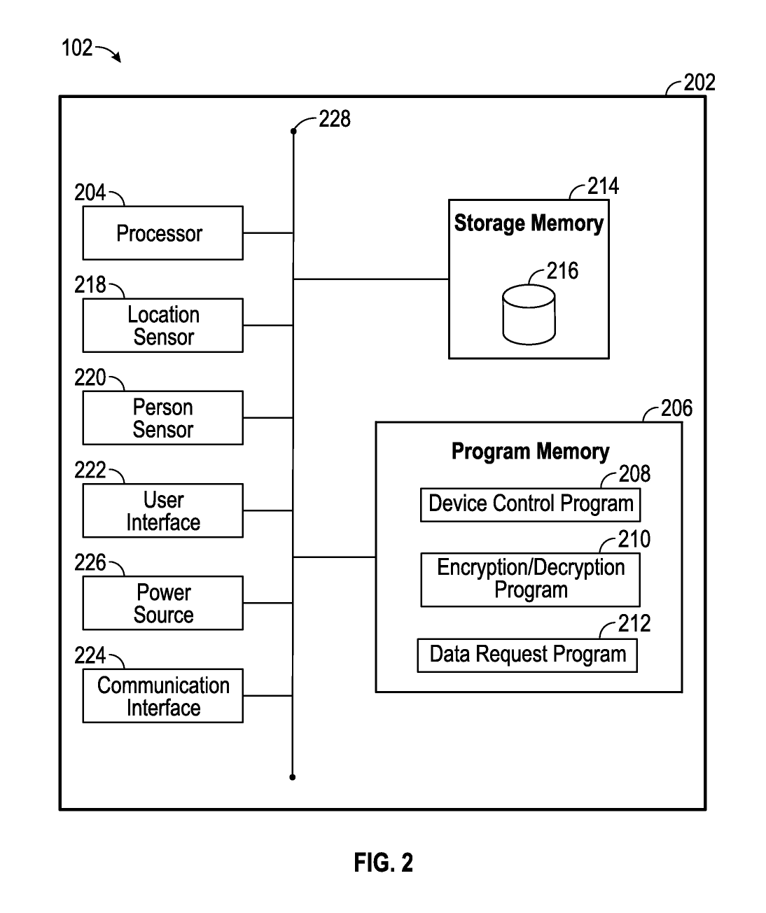

Referring to FIG. 2, a block diagram of logging device 102 is shown according to one embodiment. Logging device 102 includes housing 202. Housing 202 is configured to be carried by (e.g., hand carried, worn by, implanted within) an individual (i.e., the person corresponding to the data generated by logging device 102). Housing 202 may include a clip (e.g., a belt clip, a clothes clip, etc.) or a strap (e.g., a watch strap, a necklace chain, a handle, an ankle bracelet, etc.) such that logging device 102 may be worn by an individual. In some embodiments, logging device 102 may be implanted within an individual. As discussed in further detail below, in order to ensure the accuracy of the data generated by logging device 102, the individual may be required to periodically check in with logging device 102 or periodically verify that logging device 102 is on or with the individual.

Logging device 102 includes processor 204 and program memory 206. Processor 204 controls the operation of logging device 102 by executing various program modules stored in program memory 206. The program modules may include any of device control program module 208, encryption/decryption program module 210, data request program module 212, and any other program modules. Device control program module 208 includes instructions that, when executed by processor 204, control the general operation of logging device 102. Encryption/decryption program module 210 includes instructions that, when executed by processor 204, encrypt the data generated by logging device 102 and selectively decrypt generated data upon receipt of a proper data request. Data request program module 212 includes instructions that, when executed by processor 204, control access to data generated by logging device 102 by providing the appropriate amount of generated data to authorized and authenticated users and devices. Accordingly, data request program module 212 may include any necessary requestor permission levels and the associated data resolutions associated with each permission level.

Logging device 102 includes storage memory 214. In some arrangements, storage memory 214 and program memory 206 are contained on a single memory device. In other arrangements, storage memory 214 and program memory 206 are separate memory devices. Storage memory 214 includes database 216 of data generated by logging device 102. Database 216 includes individual entries generated by logging device. Each entry in database 216 includes location information, time information, and optionally person validation information. The location information includes high resolution location information (e.g., an address, a set of GPS coordinates, etc.). The high resolution location information may be output by logging device 102 during a data request in the high resolution form (e.g., as the address, as the set of GPS coordinates, etc.) or output as a lower resolution form (e.g., reported as a neighborhood, as a city, as a county, as a state, as a country, etc.). The time information includes high resolution time information that includes a specific time (e.g., an hour indicator, a minute indicator, a second indicator, and a time zone indicator) of a specific day of a specific year. The high resolution time information may be output by logging device 102 during a data request in the high resolution form or output as a lower resolution form (e.g., a certain time range, as a date, as a month, as a year, etc.). The resolution to which the entries in database 216 are reported is dependent on the identity of the authorized data requestor and/or the purpose of the data request. The person validation information includes information that associates the entry to a specific individual. In some embodiments where logging device 102 is assigned to a single individual, the person validation information may be common to all location-time entries, and not independently stored with each location-time entry. In other embodiments where logging device 102 is used by multiple individuals, the person validation information may be independently stored with each location-time entry. As described above, logging device 102 can also present both the time and location aspects of the location-time data in an indirect manner (e.g., as answers to yes or no questions). In some arrangements, storage memory 214 is write-only memory that can only be read by a specialized device. In such arrangements, once logging device 102 stores data on storage memory 214, it cannot be read (and thus edited) at a later point by logging device 102. Accordingly, storage memory 214 may be removable (e.g., embodied as a removable memory module such as an SD card, a MicroSD card, a compact flash card, etc.) such that storage memory 214 may be received in a specialized device configured to read the write-only memory. In some arrangements, storage memory 214 is write-once memory (e.g., a write once read many or “WORM” memory) that cannot be modified once written. Embodiments of write-once memories include Secure Digital™ flash memory, the Memory Vault product of SanDisk, or WORM hard disk drives from Green-Tec USA. Various WORM memory devices based on organic components are described in “Organic-inorganic heterojunction WORM memory”, by Xin-Xu, which is available at https://www.princeton.edu/˜ocmweb/projects/Organic/WORM/worm.htm; “A polymer/semiconductor write-once read-many-times memory”, by S. Moller, et al, Nature 426 (6963): 166-169 (2003); and “Realization of write-once-read-many-times memory devices based on poly(N-vinylcarbazole) by thermal annealing”, by J. Lin, D. Ma, Appl. Phys. Lett. 93, 093505 (2008).

Each entry in database 216 is stored in a tamper-proof manner (e.g., edit protected). The edit protected status is achieved through encryption (e.g., encryption via encryption/decryption program module 210), through use of write-protected memory (e.g., memory 214 is write-only memory that can only be read by a special device thereby preventing editing of data in database 216), through use of write-once memory, by logging the data and memory location of each data write event, or by tagging each entry with a digital watermark. Write-protection may be achieved through software write-protection or hardware write-protection. Accordingly, each entry in database 216 may be certified to be authentic (e.g., not tampered with or altered) such that the information logged by logging device 102 may be relied on in an official manner (e.g., may be used to prove a person's whereabouts at a specific time).

Still referring to FIG. 2, logging device 102 includes location sensor 218. Location sensor 218 provides location information to processor 204. The location information includes the high resolution location information as described above. In one embodiment, location sensor 218 includes at least one of a GPS receiver, a GLONASS receiver, an inertial sensor (e.g., one or more accelerometers or gyroscopes), a cellular antenna (i.e., for gathering location information based on cellular signal triangulation), and the like. In some embodiments, multiple different types of location sensors are provided and can be used together or independently (e.g., GPS sensors can be used to periodically provide location references for inertial sensors).

Logging device 102 includes person sensor 220. Person sensor 220 provides person validation information to processor 204. As described above, the location and time information generated by logging device 102 relate to a specific individual. Accordingly, the logging device 102 determines whether the individual associated with the logging device 102 is indeed at or near the location of the logging device 102 when an entry is made in database 216. In some arrangements, person sensor 220 is a proximity sensor that determines whether logging device 102 is near a person. In such arrangements, if logging device 102 is near a person, the logic of logging device 102 may assume the person is the individual associated with the logging device. The proximity sensor may include a heartbeat monitor, a radar sensor, a camera, or a thermal sensor. In other arrangement, the person sensor 220 includes a biometric sensor such as a fingerprint scanner, a retina scanner, a DNA reader, a voice recognition scanner (e.g., a microphone), a camera (e.g., for facial recognition), etc. In such an arrangement, the person may be prompted to enter biometric information at the time an entry is created (e.g., via a user interface such as user interface 222).

Logging device includes user interface 222. User interface 222 is an input and output interface. Accordingly, user interface 222 allows a user to program logging device 102 and to receive information from logging device 102. User interface 222 may include any combination of switches, buttons, dials, lights, speakers, displays, or the like. In some arrangements, user interface 222 is a touchscreen display. In some arrangements, user interface 222 is used instead of or supplements the information provided by person sensor 220. Through user interface 222, the associated individual can provide a password, a code, a signature, a PIN, a user identification, or a combination thereof to verify that the individual is at or near the location of logging device 102.

Still referring to FIG. 2, logging device 102 includes communication interface 224. Communication interface 224 allows for data transfer between logging device 102 and various external computing devices (e.g., access device 110, server 104, etc.). In some embodiments, data transferred via communication interface 224 is encrypted to enhance security of the data. Communication interface 224 includes at least one of a wired network connection (e.g., Ethernet port, USB port, fiber optic port, etc.) and a wireless network connection (e.g., WiFi transceiver, Bluetooth transceiver, ZigBee transceiver, etc.). In some arrangements, communication interface 224 also provides location information to supplement location information from location sensor 218 or as a substitute for location sensor 218 when location sensor 218 is unable to determine a location (e.g., if the person is indoors and cannot receive a GPS signal). In such arrangements, the location information is location data associated with a network identifier (e.g., a WiFi SSID, a Bluetooth beacon, or the like).

Logging device 102 includes power source 226. In some arrangements, power source 226 is a battery. The battery may be a rechargeable battery (e.g., a lithium ion battery, a lithium ion polymer battery, a nickel cadmium battery, etc.) or a disposable alkaline battery. Power source 226 may be or include a power input port to receive grid power (e.g., to charge a rechargeable battery).

The above described components of logging device 102 are connected via bus 228. Bus 228 allows for electrical power transmission from power source 226 to the various components of logging device 102. In an alternative arrangement, various components, including processor 204, program memory 206, storage memory 214, location sensor 218, person sensor 220, and communication interface 224 are part of a system-on-chip arrangement.

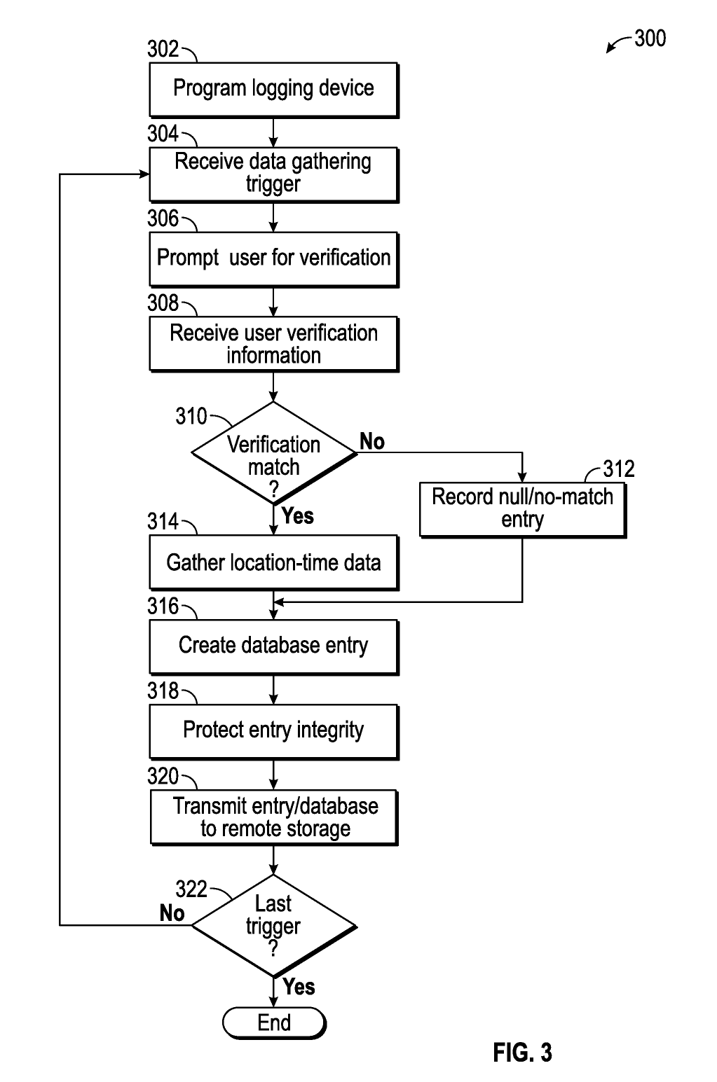

Referring to FIG. 3, a flow diagram of method 300 of operating a location-time logging device (e.g., logging device 102) is shown according to one embodiment. The location-time logging device generates location-time information corresponding to an individual associated with the location-time logging device. The generated information is edit-protected such that the information cannot be tampered with by the individual or another party.

Method 300 beings when the location-time logging device is programmed (302). The programmed information is received by a processor (e.g., processor 204) of the logging device and stored in a memory (e.g., program memory 206). The location-time logging device is programmed via a user interface (e.g., user interface 222) or via an external computing device (e.g., the individual's laptop, tablet, smartphone; a system server; access device 110; etc.) in communication with the location-time logging device. The logging device is programmed with user information. The user is the individual associated with the data generated by the logging device. The user information includes any of a user identifier (e.g., a name, a username, a serial number, etc.) and user verification information. The user verification information is used to verify that the logging device is being carried by the user (or is near the user) at the time of data gathering. In some arrangements, the user verification information includes a password or a PIN. In other arrangements, the user verification information includes previously verified biometric information (e.g., a fingerprint, a voice sample, a retina scan, a facial image, DNA, etc.). The biometric information may be previously verified or certified by a trusted external entity (i.e., a third party). For example, the user may provide biometric samples to the trusted external entity for verification that the user is who they claim to be prior to programming the biometric information into the logging device.

In one embodiment, the logging device is programmed with data gathering trigger events. As described below, the occurrence of a trigger event causes the logging device to generate and store location-time information. In some embodiments, location-time information is continually being generated, but is only stored upon occurrence of the trigger event. The programmed trigger events may include a schedule of trigger events, the enabling of on-demand trigger events by the individual, trigger events based on the location of the logging device (e.g., when the determined location of the logging device enters or leaves a geographic region), trigger events based on other physical characteristics detected by the logging device (e.g., speed of the logging device, movement distance, etc.), and external trigger events (e.g., detecting that the user of the logging device is making or receiving a phone call, detecting that the user of the logging device is driving, etc.). The schedule of trigger events includes timing parameters as to when the triggers are internally initiated by the logging device. The logging device may be programmed to generate the triggers (e.g., automatically generate location-time data) at a given interval (e.g., every set number of minutes, every set number of hours, every set number of days, etc.) or according to a schedule (e.g., based on a date and time). The scheduled date and time can repeat throughout a designated period of time. The trigger events based on the location of the logging device are determined by the processor of the logging device based on feedback from a location sensor (e.g., location sensor 218). Trigger events based on a command from the individual may be subject to verification (e.g., biometric, code, etc.) of the individual's identity. In some embodiments, a trigger event can automatically be generated whenever the logging device verifies the individual's proximity and identity. Trigger events based on external events (e.g., a trigger based on determining the user is making or receiving a phone call) may require a data connection between the logging device and an external computing device, such as the user's cell phone or a car infotainment system.

In some embodiments, the logging device is programmed with data permission information (i.e., who can request, who can delete, who can redact, etc.). In some arrangements, the generated location-time data is access restricted. The access restrictions may be arranged in a number of tiers. For example, a first set of individuals and/or entities (or user identities) are associated with a first permission level that provides access to the entirety of data generated by the logging device (e.g., the high resolution data as discussed above), while a second set of individuals and/or entities (or user identities) are associated with a second permission level that provides access to a limited version of data generated by the logging device (e.g., the lower resolution data as discussed above). There may be more than two tiers or levels of permission. Each tier or level has a different set of permissions than the other tiers or levels. The permissions may be set by the individual associated with the logging device. Such permissions can specify the users, their access level, which location-time data they can access, the resolution of location-time data they can access, a number of data accesses they are permitted, a time range the permission is valid for, etc.

In further embodiments, the logging device is programmed with other operational parameters. In some arrangements, the logging device is programmed with data upload information. In such arrangements, the logging device is programmed with a server identifier (e.g., an IP address, a web address etc.) for periodic uploads of gathered location-time information. In some arrangements, the logging device is programmed with communication preferences (e.g., network connection preferences including network SSIDs and/or network access codes) to enable data transmission via trusted networks. The programmed network preferences may also serve to assist with generating location information (as discussed above and as discussed in further detail below).

After the logging device is programmed, a data gathering trigger is received (304). The data gathering trigger is received by the processor of the logging device. The trigger may be an internal trigger (e.g., corresponding to a preprogrammed data timing parameters) or an external trigger (e.g., corresponding to an on-demand request from the individual, corresponding to a trigger received from an external computing device, etc.). The trigger indicates to the logging device that location-time data is to be gathered about the individual.

The user is prompted for verification that the individual is with (or near) the logging device (306). The logging device prompts the individual by initiating a notification to the individual via a user interface (e.g., user interface 222). The notification may include causing the logging device to vibrate, displaying a message on a display of the user interface, emitting an audio alert, causing a notification light (e.g., an LED) to flash, or a combination thereof. In some arrangements, the notification is sent via an e-mail or text message alert. In some arrangements, prompting the individual for verification (306) is optional. The logging device may be programmed to gather location and time data based on an automatic reading that the logging device is being carried by the individual. The logging device makes such a determination based on feedback signals from a user sensor (e.g., a heartbeat monitor, a thermal sensor, etc.) that indicates the logging device is being carried by a specified individual. In such arrangements, method 300 skips 306 through 312.

User verification information is received (308). The user verification information is provided via an user input of the logging device. In some arrangements, the user verification information is provided via the user interface of the logging device (e.g., user interface 222). In such arrangements, the verification information relates to a username, a password, a PIN, or a combination thereof. In other arrangements, the verification information is provided through a biometric sensor (e.g., person sensor 220). In such arrangements, the individual may provide fingerprint information (e.g., in arrangements where the logging device includes a fingerprint scanner), retinal scan information (e.g., in arrangements where the logging device includes a retina scanner or camera), a voice sample (e.g., in arrangements where the logging device includes a microphone), a DNA sample (e.g., in arrangements where the logging device includes a DNA scanner), or a combination thereof. In still further arrangements, the verification information includes a combination of entered information through the user interface and biometric information provided through a biometric scanner.

The received user verification data is compared against stored user verification information to determine if the received information matches (310). As discussed above, the logging device is programmed with previously verified user information. The user is the individual associated with the data generated by the logging device. The user information includes any of a user identifier (e.g., a name, a serial number, etc.) and user verification information. The logging device uses the previously verified user information to verify the individual by comparing later provided user information (i.e., the information received at 308) with the previously verified information. If the provided information from 308 matches the previously verified information, the individual is verified. If the provided information does not match the previously verified information from 308, the individual is not verified.

If the received information does not match, a null or no-match entry is recorded (312). The entry is recorded by the logging device and may be stored in a storage memory of the logging device (e.g., memory 214). The entry may be stored within a database in the storage memory (e.g., database 216). The entry includes an indication that the individual was not verified. Such an entry may correspond to a non-authorized user attempting to record a location-time entry posing as an authorized user of the logging device. If the trigger event is a scheduled trigger event (i.e., not an on-demand request), the entry can also indicate that no user information was provided at 308. In such a situation, the entry may indicate that the individual was not present at the time of the location-time data gathering. The null or no-match entry may include location-time data (e.g., as generated below with respect to 318).

If the received information does match, location-time data is gathered (314). The location-time data is generated by the logging device. The logging device includes a location sensor (e.g., location sensor 218). The location sensor provides location information to the processor of the logging device. The location information includes the high resolution location information as described above with respect to logging device 102. The location sensor 218 may include any of a GPS receiver, a GLONASS receiver, an inertial sensor, a cellular antenna (e.g., for gathering location information based on cellular signal triangulation), and the like. The processor of the logging device combines the location information with time information generated by the processor. The time information corresponds to the time when the location information was gathered.

An entry in a database associated with the individual is created (316). The processor of the logging device creates an entry of the location-time data in the storage memory (e.g., storage memory 214) of the logging device. The entry may be stored in a database (e.g., database 216) within the storage memory. The entry includes the high resolution location-time data generated at 314. The high resolution location-time data may later be reported by the logging device at a lower resolution as described below with respect to method 400 and as described above with respect to logging device 102.

The integrity of the entry is protected (318). The integrity of the entry is protected by the logging device such that the entry cannot be modified after it is created. In some arrangements, the logging device protects the integrity of the entry via encryption. In such arrangements, the processor of the logging device encrypts the entry by executing an encryption routine (e.g., encryption/decryption program module 210). Each individual entry may be encrypted or the entire database may be encrypted. The private key needed to decrypt the entry and/or the database is user-unknown such that only authorized users or devices are able to decrypt the encrypted data. In other arrangements, the entry and the database are stored in a write-once memory. In other arrangements, the entry and the database are stored in a write-only memory. In such arrangements, the database containing the entries cannot be accessed (i.e., read) by the logging device. Rather, the memory must be physically removed from the logging device and installed in a device capable of reading the write-only memory. In yet another arrangement, a digital watermark is applied to each entry. Later modification of the entry after its initial creation would destroy the watermark thereby providing an indication of tampering of the entry.

In some arrangements, the database and/or the entry is transmitted to a remote storage location (320). The logging device transmits the entire database or individual entries to a remote storage location (e.g., server 104) via a communication interface (e.g., communication interface 224). The logging device transmits each entry after each entry is created or in batches (e.g., batches of N entries after the Nth entry is created). In some embodiments, the data may be encrypted during this transmission. In other arrangements, the logging device transmits the entire database stored locally in the memory of the logging device. After transmission, the entries and/or the database may be removed from the local memory of the logging device or may remain in the local memory of the logging device.

The logging device determines if the trigger is the last expected trigger (322). If the received trigger (i.e., the trigger received at 304) is the last trigger, the method 300 ends. The trigger is the last trigger if the trigger received at 304 was an on-demand type of trigger or if the trigger is the last scheduled trigger in a group of triggers. If the received trigger is not the last trigger, the method returns to 304 and waits for the next trigger.

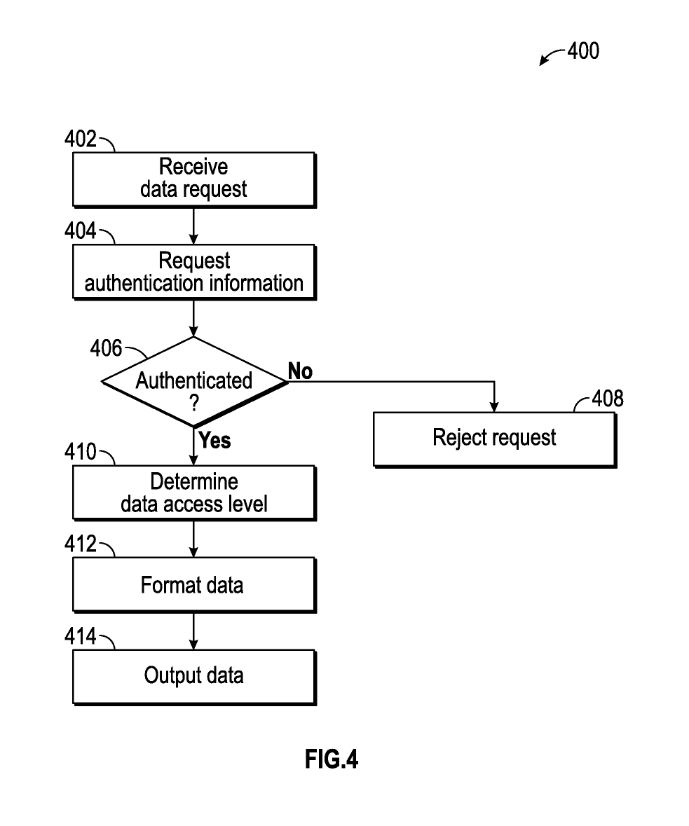

Referring to FIG. 4, a flow diagram of method 400 of accessing data logged by a location-time logging device (e.g., logging device 102) via the logging device is shown according to one embodiment. Method 400 begins when a data request is received (402) The data request is received by a processor (e.g., processor 204) of the logging device through a user interface (e.g., user interface 222). The data request includes a request for a portion of location-time data generated by the logging device. The portion may relate to a specific location-time entry, a set of location-time entries, or an entire database of location-time entries created by the logging device. The entry or set entries are stored in a database (e.g., database 216) in a storage memory (e.g., storage memory 213) of the logging device. In some arrangements, the data request additionally includes any of an identity of the requestor and a purpose of the data request.

Before granting access to the requested information, the requestor is authenticated. Accordingly, if the authentication information does not accompany the request for information, the authentication information is requested from the requestor (404). The logging device may request the authentication information via a display of the user interface. In response, the requested information includes any of a user identifier (e.g., a username), an organization identifier, a password, a PIN, a biometric, or a combination thereof. The requestor provides the required information via the user interface (e.g., via a touchscreen input on the user interface of the logging device).

The logging device determines if the requestor is authorized to access the requested information (406) The logging device compares the provided information (received in response to 404) with stored information relating to authorized users. If the provided information does not match the stored information relating to an authorized user, the data request is rejected (408). The rejection may be communicated by the logging device to the requestor via the user interface.

If the requestor is authorized, a data access level is determined (410). The requestor's access level is determined by the processor based on the permissions set by the individual associated with the location-time data; these may be based on the identity of the authorized requestor and/or the purpose of the data request. As described above, depending on the authorized requestor's access level, location-time data may be reported at levels ranging from a high resolution level (most precise) to a low resolution level (least precise). For example, depending on the access level, the location portion of the data may be reported as the specific address (most precise), as a neighborhood, as a town or city, as a county, as a state or province, or as a country (least precise). Similarly, depending on the access level, the time portion of the data may be reported as the specific time of the specific date (most precise), as a specific hour of a specific date, or as a specific date (least precise). In some arrangements, the data access level or the data request only provides access to yes or no questions. In such arrangements, the location-time data is only reported in the form of yes or no answers in response to questions. The specific level of access may vary from request to request. The access level may depend on the identity of the requestor (e.g., a police officer, a lawyer, an employer, a family member, etc.), a profession of the requestor, a relationship of the requestor to the individual associated with the requested data, a purpose of the data request (e.g., court testimony, employment background check, family requests, personal requests of the individual, etc.), and a level of access granted by the individual associated with the location-time data.

After determining the access level, the requested data is formatted according to the determined data access level (412). The requested data is formatted by the processor of the logging device. As described above, certain data requestors do not possess the appropriate access level to view the high resolution location-time data. Accordingly, the processor is configured to lower the resolution of the location-time data to a resolution consistent with the determined access level of the requestor.

The formatted data is output (414). In some arrangements, the formatted data is output via a display of the user interface. In other arrangements, the formatted data may be transmitted to an external device (e.g., a cell phone, access device 110, etc.) via a communication interface of the logging device (e.g., communication interface 224). The transmitted data may be attached to a message, such as an e-mail message sent to an e-mail account associated with the requestor.

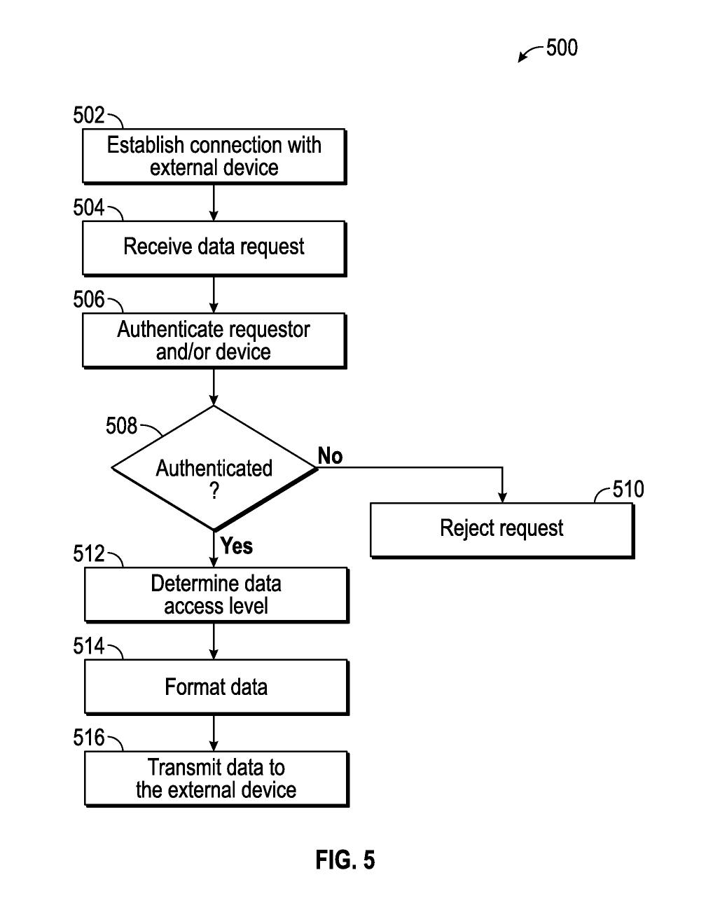

Referring to FIG. 5, a flow diagram of method 500 of accessing data logged by a location-time logging device (e.g., logging device 102) via an external computing device is shown according to one embodiment. Method 500 is similar to method 400. The primary difference between method 500 and method 400 is how the logged data is accessed. In method 500, the data is accessed through an external computing device (e.g., access device 110) as opposed to an onboard user interface of the logging device (e.g., user interface 222; as done in method 400). Method 500 begins when a connection is established with the external computing device (502). The external computing device may by any of a desktop computer, a laptop computer, a PDA, a cell phone, a smart phone, a tablet computer, a portable media device, or the like. A processor of the logging device (e.g., processor 204) establishes the connection with the external computing device via a communication interface of the logging device (e.g., communication interface 224). In some arrangements, the connection is a direct connection between the logging device and the external computing device. The direct data connection may be a wired connection (e.g., via a USB cable, via an Ethernet cable, fiber optic, etc.) or a wireless connection (e.g., via a Bluetooth connection, via a WiFi connection such as an 802.11a/b/g/n connection, via a ZigBee connection, via an infrared connection, via an ultrasound connection, etc.). In other arrangements, the connection is an indirect connection in which data communication between the logging device and the external computing device is facilitated by an intermediate network (e.g., network 108) or computing device.

After the data connection is established, a data request is received (504) The data request is received by the processor of the logging device via the communication interface. The data request includes an identity of a requested portion of the location-time information. The requested portion of the location-time information may include a targeted location-time entry or set of location-time entries created by the logging device. The entry or set of entries may be stored in a database (e.g., database 216) in a storage memory (e.g., storage memory 213) of the logging device. The data request also includes an identity of the requestor and/or the requesting device. In some arrangements, the data request also includes a purpose of the data request.

Before granting access to the requested information, the requestor (i.e., the user of the external computing device) is authenticated (506). In some arrangements, more information than provided in the initial data request is needed to authenticate the requestor. Accordingly, additional authentication information is requested. The logging device requests the authentication information by transmitting a request through the communication interface to the external computing device. In response, the logging device may receive a reply message including the requested information from the external computing device. The requested information may include a user identifier (e.g., a username), an organization identifier, a password, a PIN, a biometric, or a combination thereof.

The logging device determines if the requestor is authorized to access the requested information (508) The logging device compares the provided information from the requestor with stored information relating to authorized users. If the provided information does not match the stored information relating to an authorized user, the data request is rejected (510). The rejection of the request is communicated via a message sent from the logging device to be communicated by the logging device to the requestor via the user interface.

If the requestor is authorized, a data access level is determined (512). The requestor's access level is determined by the processor based on the permissions set by the individual associated with the location-time data; these may be based on at least one of the identity of the authorized requestor and the purpose of the data request. As described above, depending on the authorized requestor's access level, location-time data may be reported at levels ranging from a high resolution level (precise) to a low resolution level (imprecise). For example, depending on the access level, the location portion of the data may be reported as the specific address (most precise), as a neighborhood, as a town or city, as a county, as a state or province, or as a country (least precise). Similarly, depending on the access level, the time portion of the data may be reported as the specific time of the specific date (most precise), as a specific hour of a specific date, or as a specific date (least precise). The specific level of access may vary from request to request. The access level may depend on the identity of the requestor (e.g., a police officer, a lawyer, an employer, a family member, etc.), a purpose of the data request (e.g., court testimony, employment background check, family requests, personal requests of the individual, etc.), and a level of access granted by the individual associated with the location-time data.

After determining the access level, the requested data is formatted according to the determined data access level (514). The requested data is formatted by the processor of the logging device. As described above, certain data requestors do not possess the appropriate access level to view the high resolution location-time data. Accordingly, the processor is configured to lower the resolution of the location-time data to a resolution consistent with the determined access level of the requestor. The low resolution location-time data may be formatted in the form of a reply to a yes or no question.

The formatted data is output (516). The formatted data is sent from the logging device by the processor and through the communication interface to the external computing device. The transmitted data may be attached to a message, such as an e-mail message sent to an e-mail account associated with the requestor.

In some arrangements, requestors (i.e., users requesting data) can request data from a remote data storage device (e.g., server 104) via a computing device (e.g., access device 110). In such arrangements, the method of requesting the data from the perspective of the remote data storage device is substantially the same as method 500 (substituting the remote data storage device for the logging device as described above with respect to method 500).

The above described systems and methods describe the logging devices (e.g., logging device 102) as single purpose devices (i.e., devices having a primary purpose of logging location-time data about a user). However, the above described logging devices may be incorporated into other portable electronic devices already carried by many individuals. For example, many smartphones have a significant amount of overlap with the above described components of logging device 102. Accordingly, it is contemplated that the above described logging devices may be incorporated as an application running on a smartphone or a PDA.

In some arrangements, the user associated with the above described logging devices may be provided limited edit capabilities of logged data. In such arrangements, the limited edit capabilities include redaction of portions of entries and/or deletion of entries. The redaction of entries can offer a capability to “retract” a trigger event, i.e., it functions as though the corresponding trigger event never occurred. Accordingly, some location-time data associated with the user can be redacted or deleted while other data is maintained on the logging device. Hence, the location-time data stored by the logging device is generally incomplete (i.e., location-time data is only stored at trigger events approved by the device's individual), but location-time data that is recorded is assured to be accurate, (i.e., data is securely stored in a non-editable fashion).

It is important to note that the construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the enclosure may be constructed from any of a wide variety of materials that provide sufficient strength or durability, in any of a wide variety of colors, textures, and combinations. Accordingly, all such modifications are intended to be included within the scope of the present inventions. The order or sequence of any process or method steps may be varied or re-sequenced according to alternative embodiments. Other substitutions, modifications, changes, and omissions may be made in the design, operating conditions, and arrangement of the preferred and other exemplary embodiments without departing from scope of the present disclosure or from the spirit of the appended claims.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures may show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps, and decision steps.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A personal location and time logging device comprising:
a location detector;
a secure memory; and
a processor configured to:
receive location information from the location detector,
generate location-time data based on a trigger, the location-time data associated with an individual carrying the device,
store the location-time data in the secure memory, and
provide restricted access to the location-time data based on a permission of the individual.

2. The device of claim 1, further comprising a communication interface configured to send data to or to receive data from an external device.

3. The device of claim 2, wherein the trigger is received from the external device.

4. The device of claim 2, wherein the processor is further configured to transmit the location-time data to the external device.

5. The device of claim 4, wherein the processor is further configured to downgrade a resolution of the location-time data prior to transmitting the location-time data to the external device.

6. (canceled)

7. The device of claim 1, wherein the permission of the individual is based upon at least one of a code, a key, a biometric identity, and a signature.

8. The device of claim 1, wherein the permission of the individual comprises at least one of an identity of a user being granted restricted access to the data, a level of access, and a specification of which location-time data the restricted access is for.

9. (canceled)

10. The device of claim 1, wherein the trigger is received based on the location.

11. (canceled)

12. (canceled)

13. The device of claim 1, wherein the trigger is received from the individual.

14. The device of claim 13, wherein the processor is configured to verify the identity of the individual providing the trigger.

15. The device of claim 1, further comprising a biometric sensor.

16. The device of claim 15, wherein the trigger is received based on a match between sensed biometric information from the individual with a previously verified biometric information of the individual.

17-20. (canceled)

21. The device of claim 15, wherein the processor is configured to compare a sensed biometric information from the individual with a previously verified biometric information of the individual to verify that the individual is near the device when the location-time data is generated.

22. The device of claim 1, further comprising a proximity sensor configured to detect the presence of the individual at the logging device.

23. The device of claim 22, wherein the proximity sensor includes a heartbeat monitor, a radar sensor, or a thermal sensor.

24. The device of claim 22, wherein the proximity sensor includes a biometric sensor.

25. (canceled)

26. The device of claim 1, wherein the secure memory is write-only memory.

27. (canceled)

28. (canceled)

29. The device of claim 1, wherein the secure memory is configured to log at least one of the time and device location for each data write.

30. The device of claim 1, wherein the secure memory is write-once memory.

31-43. (canceled)

44. A system for generating and storing location-time data relating to a tracked individual, the system comprising:
an individual carried logging device including a location detector, a processor, a logging device memory, and a logging device communication interface, wherein the logging device is configured to generate location-time data associated with the tracked individual based on the occurrence of a trigger and to store the location-time data in the memory; and
a system server including a server secure memory and a server communication interface;
wherein the logging device is configured to transmit the location-time data to the system server for storage in the server secure memory; and
wherein access to the location-time data is provided on a restricted basis based on permission of the individual.

45. (canceled)

46. The system of claim 44, further comprising an access device.

47. The system of claim 46, wherein the access device is configured to receive the location-time data from the logging device memory via the logging device communication interface.

48. The system of claim 47, wherein the logging device is configured to downgrade a resolution of the location-time data prior to sending the location-time data to the access device.

49. The system of claim 46, wherein the access device is configured to access the location-time data from the server secure memory via the server communication interface.

50. (canceled)

51. The system of claim 44, wherein the access comprises confirming or denying that the location-time data is within a specified interval from a specified location-time value.

52-57. (canceled)

58. The system of claim 44, wherein the logging device memory is configured to log at least one of the time and device location for each data write.

59-64. (canceled)

65. The system of claim 44, wherein the logging device further comprises a biometric sensor.

66. The system of claim 65, wherein the trigger is received based on a match between sensed biometric information from the individual with a previously verified biometric information of the individual.

67-69. (canceled)

70. The system of claim 44, wherein the logging device further comprises a proximity sensor configured to detect the presence of the individual at the logging device.

71-82. (canceled)

83. A method of securely recording location-time information associated with individual via a logging device carried by the individual, the method comprising:
receiving, via a processor of the logging device, a data gathering trigger;
receiving, via an input of the logging device, user verification information from the individual;
authenticating, via the processor, an identity of the individual based on comparing the received user verification information with previously verified user information to verify the presence of the individual at or near the logging device;
receiving, at the processor, location information from a location sensor of the logging device;
creating, by the processor, a location-time entry including the location information and time information corresponding to a time of the location information; and
storing, in a secure memory of the logging device, the location-time entry.

84-88. (canceled)

89. The method of claim 83, further comprising encrypting, by the processor, the location-time entry stored in the secure memory.

90. The method of claim 89, wherein the encrypting the location-time entry is done with an individual-unknown encryption method.

91-99. (canceled)

100. The method of claim 83, further comprising detecting, through the location sensor, that a location of logging device matches a programmed location, wherein the data gathering trigger relates to an occurrence of the logging device entering or leaving the programmed location.

101. (canceled)

102. (canceled)

103. The method of claim 83, further comprising receiving programming instructions for the logging device including data permission information relating to access permissions for the location-time entry.

104. The method of claim 103, wherein the data permission information includes a first association of a first user with a first access level, the first access level providing the first user with access to all of the information in the location-time entry.

105-158. (canceled)
